(19) United States
(12) Patent Application Publication
(10) Pub. No.: US 2007/0018001 A1
(43) Pub. Date: Jan. 25, 2007

(54) Optical data storage medium and its production and use

(75) Inventors: Mehmet-Cengiz Yesildag, Leverkusen (DE); Bernd Post, Moers (DE); Rainer Hagen, Leverkusen (DE); Serguei Kostromine, Swisttal (DE); Klaus Meyer, Dormagen (DE); Rafael Oser, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/451,971

(22) Filed: Jun. 13, 2006

(30) Foreign Application Priority Data
Jun. 17, 2005 (DE) 102005028145.1

(51) Int. Cl. G06K 19/00

(52) U.S. Cl. 235/487

(57) ABSTRACT

An optical storage medium having a layered structure suitable for use in security application, such as, e.g. smart cards or smart labels is disclosed. The medium comprises (a) a photoaddressable layer that includes a polymer the molecular structure of which includes at least one structural unit conforming to formula (I) 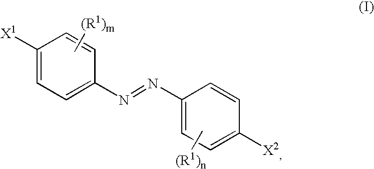 and (b) substrate layer. Embodiments of the medium that further include at least one member selected from the group consisting of a transparent barrier layer, reflection layer and an adhesive layer, interposed between the photoaddressable layer and the substrate layer are also disclosed.

### FIELD OF THE INVENTION

The invention relates to an optical storage medium and in particular to an optical multi layered medium.

### TECHNICAL BACKGROUND OF THE INVENTION

Cards of plastic of cheque card size which, according to the current state of the art, comprise an intelligent storage element in the form of an electronic chip having storage and calculation functionality are called smart cards. Typical values for an electronic chip are: 8-bit microprocessor; 5 MHz cycle rate; 40-60 kilobytes storage volume.

Due to the integrated, independent mode of functioning, smart cards are employed for uses which require a high level of security. This means security against forging, data security and authentication.

Typical uses for smart cards are:
identity cards (“ID cards”) for proving the identity of the card holder
patient cards for storing medical data on a person
credit and bank cards for electronic financial transactions

New uses are distinguished in particular by the combination of various functions in a so-called multifunction card (“multi-application card”). On the basis of the diverse uses, the multifunction card is also called an electronic wallet.

Future generations of multifunction cards will become more and more a part of daily life, i.e. will also integrate a larger number of various functions in one card. An appropriate security level according to the nature of the data will therefore be required, it being necessary for the security level delivered by the card to meet the highest demands.

A current example of such a combination which is expedited by an increased need for security is the combination of biometry with smart cards and identity cards. The latter include staff identity cards, passports, driving licences, access cards etc., which, like smart cards, comprise a composite film of plastic with an integrated storage chip.

The main requirements of the future generations of the card types described are:
Sufficient storage capacity for digital and analogue data
High data security, which is ensured by technical solutions regarding reading authorization, writing authorization and copying protection
Scalable data security, i.e. ability to differentiate between data of a different confidentiality or security level
Upgradeability (technology upgrades), so that future biometric methods and new multiple uses can also be integrated
Low system complexity regarding the layer construction with its storage and security elements and the integration into a card or a document

So-called photoaddressable polymers form the basis of these optical data storage media.

Polymers and copolymers which contain side groups and are distinguished by a very wide possibility of variation in properties are particularly suitable for data storage medium purposes. Their particular peculiarity is that their optical properties, such as absorption, emission, reflection, birefringence and scattering, can be modified reversibly in a light-induced manner. Examples of this type are the side group polymers according to U.S. Pat. No. 5,173,381 containing azobenzene groups. These belong to the class of photoaddressable polymers.

The term photoaddressable polymers characterizes the ability to develop an aligned birefringence when irradiated with polarized light. The birefringence pattern written in can be rendered visible in polarized light. It is furthermore known that in layers of these polymers, a locally demarcated birefringence may be written in with polarized light at any desired point, the preferred axis thereof also moving as the polarization direction rotates. The aligned birefringence develops according to the interference pattern in the case of holographic exposure to light, and leads to light diffraction. Holographic storage of analogue or digital information is thus also possible.

As a holographic recording medium, photoaddressable polymers may be integrated e.g. into optical cards.

There is the need for novel products of secure future which meet all the stated requirements at the same time.

The object of the invention is therefore to provide optical data storage media, preferably in the form of holographic optical storage cards, so-called smart cards, which meet these requirements.

### SUMMARY OF THE INVENTION

An optical storage medium having a layered structure suitable for use in security application, such as, e.g. smart cards or smart labels is disclosed. The medium comprises (a) a photoaddressable layer that includes a polymer the molecular structure of which includes at least one structural unit conforming to formula (I) 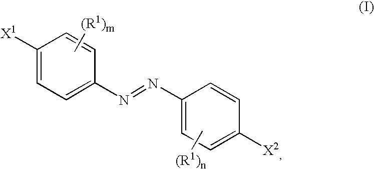
and (b) substrate layer. Embodiments of the medium that further include at least one member selected from the group consisting of a transparent barrier layer, reflection layer and an adhesive layer, interposed between the photoaddressable layer and the substrate layer are also disclosed.

### DETAILED DESCRIPTION OF THE INVENTION

It has been possible to achieve the object by the construction and the production and use of optical data storage media which have at least one layer or more generally a region which comprises an organic plastic which contains no inorganic or metallic constituents and is distinctive as a storage layer.

The present invention provides an optical storage medium comprising the following layer construction:
a) a photoaddressable layer that includes a polymer the molecular structure of which includes at least one structural unit conforming to formula (I) 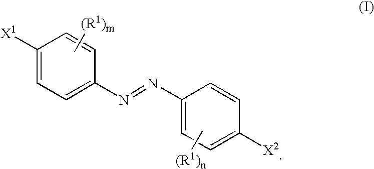
   wherein
      R¹ and R² independently of one another represent hydrogen or a nonionic substituent,
      m and n independently of one another represent an integer from 0 to 4, preferably 0 to 2,
      X¹ and X² denote X^{1′}-R³ or X^{2′}—R⁴,
      wherein
      X¹ and X² represent a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)—, —(CNR⁸—NR⁵)— or —N═N—,
      R³, R⁴, R⁵ and R⁸ independently of one another represent hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)—,
      R⁶ and R⁷ independently of one another represent hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl or
      X^{1′}—R³ and X^{2′}—R⁴ represent hydrogen, halogen, cyano, nitro, CF₃ or CCl₃,
b) optionally transparent barrier layer,
c) optionally reflection layer,
d) optionally adhesive layer,
e) substrate layer.

Nonionic substituents are to be understood as meaning halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—.

The alkyl, cycloalkyl, alkenyl and aryl radicals may in their turn be substituted by up to 3 radicals from the series consisting of halogen, cyano, nitro, C₁- to C₂₀-alkyl, C₁- to C₂₀-alkoxy, C₃- to C₁₀-cycloalkyl, C₂- to C₂₀-alkenyl or C₆- to C₁₀-aryl, and the alkyl and alkenyl radicals may be straight-chain or branched.

Halogen is to be understood as meaning fluorine, chlorine, bromine and iodine, in particular fluorine and chlorine.

The compounds of the formula (I) are covalently bonded to the polymer skeleton, as a rule via a spacer. For example, X¹ (or X²) from the formula (I) may then represent such a spacer, in particular —S¹-T¹-(Q¹)ᵢ-X^{1′},

wherein

X^{1′} has the abovementioned meaning,
Q¹ represents —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)—, —(CNR⁸—NR⁵)—, —(CH₂)ₚ—, p- or m-C₆H₄— or a divalent radical of the following structures 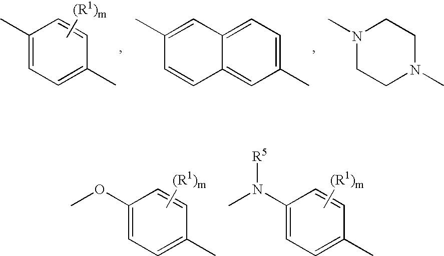
i represents an integer from 0 to 4, where for i>1 the individual Q¹ may have different meanings,
T¹ represents —(CH₂)ₚ—, wherein the chain may be interrupted by —O—, —NR⁹— or —OSiR¹⁰₂O—,
S¹ represents a direct bond, —O—, —S— or —NR⁹—,
p represents an integer from 2 to 12, preferably 2 to 8, in particular 2 to 4,
R⁹ represents hydrogen, methyl, ethyl or propyl,
R¹⁰ represents methyl or ethyl and
R⁵ to R⁸, R¹, m have the abovementioned meaning.

Photoaddressable polymers (PAP), which may be present as homopolymers or copolymers, preferably as side chain homo- and side chain copolymers, and which contain azobenzene dyestuffs in the side group, are preferred.

Suitable polymeric resins that may be made photoaddressable by the incorporation of structures conforming to formula (I) include polyacrylate, polymethacrylate, polyacrylamide, polymethacrylamide, polysiloxane, polyurea, polyurethane, polyester, polystyrene or cellulose. Polyacrylate, polymethacrylate and polyacrylamide are preferred.

The PAP preferably have glass transition temperatures T_{g} of at least 40° C., particularly preferably of at least 90° C. The glass transition temperature may be determined, for example, in accordance with B. Vollmer, Grundriss der Makromolekularen Chemie, p. 406-410, Springer-Verlag, Heidelberg 1962.

The PAP usually have a molecular weight, determined as the weight-average, of from 3,000 to 2,000,000 g/mol, preferably of from 5,000 to 1,500,000 g/mol, determined by gel permeation chromatography (calibrated with polymethyl methacrylate (PMMA)).

Azo dyestuff fragments and optionally additionally at least one grouping having form anisotropy (mesogen) are preferred as the side chain of the photoaddressable polymers.

In the case of the PAP preferably used, azo dyestuff fragments are as a rule bonded covalently to the polymer main chain via flexible spacers. The azo dyestuff fragments interact with the electromagnetic radiation and thereby modify their spatial orientation.

The mesogens are bonded in the same manner as the azo dyestuff fragments. The do not necessarily have to absorb the actinic light, because they function as a passive molecular group. They are thus not photoactive in the above sense. Their function is to intensify the light-inducible birefringence and to stabilize the system after the action of light.

The reorientation of the dyestuff fragments after the exposure to actinic light is known, for example, from studies of polarized absorption spectroscopy: A specimen exposed to actinic light beforehand is analysed between 2 polarizers in a UV/VIS spectrometer (e.g. CARY 4G, UV/VIS spectrometer) in the spectral range of the absorption of the dyestuffs. On rotation of the specimen around the normal to the specimen and with a suitable polarizer adjustment, for example in the crossed state, the reorientation of the dyestuffs follows from the course of the intensity of the extinction as a function of the specimen angle and may thereby be determined unambiguously.

The orientation of the longitudinal axis of the molecules is an important parameter. This may be determined, for example, with the aid of the molecular shape by molecular modelling (e.g. CERIUS).

Composite films which are particularly preferred are those which are characterized in that the photoaddressable organic polymer in the storage layer a) has structural units based on the compounds of the formula (II) 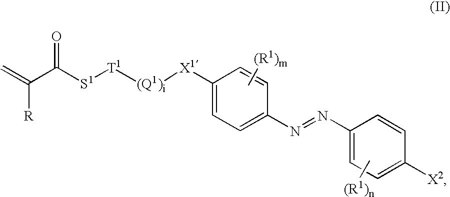
wherein
R represent hydrogen or methyl and
   the other radicals have the abovementioned meaning.

Photoaddressable polymers (PAP) which are particularly suitable are those having structural units based on compounds of the formula (II) wherein
X^{1′} denotes —(CO—O)—, —(CO—NR⁵)— and —N═N—,
Q¹ denotes 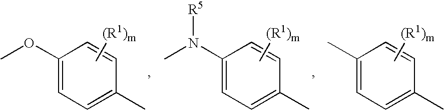
   and
i is 1
   and the other radicals have the abovementioned meaning.

Photoaddressable polymers which are particularly preferably employed are those of which the solubility in organic solvents corresponds to that of typical dyestuffs which are used for CD-R and DVD-R media. A corresponding solubility allows application of the photoaddressable polymer from the solution to the substrates of plastic, without these being modified chemically or physically.

Composite films which are particularly preferred are therefore those which are characterized in that the photoaddressable organic polymer in the storage layer a) have structural units based on the compounds of the formula (II)

wherein

X^{1′} has the abovementioned meaning
Q¹ denotes 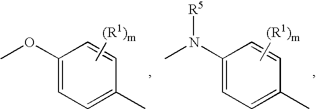
i denotes 1 and
S¹ is —NR⁹—
   and the radicals R, T¹, X², R¹, R² and R⁹ and m and n have the abovementioned meaning.

S¹ in the form of —NR⁹— imparts to the PAP the solubility in the solvents typically used for the production of CD-R and DVD-R formats, such as e.g. 2,2,3,3-tetrafluoropropanol (TFP). Thus, the PAP may be applied as the storage layer from the solution directly on to a substrate of plastic by the usual coating methods, such as e.g. knife-coating, pouring or spin coating. The surface of the plastic, in particular of the polycarbonate, is not superficially dissolved by this procedure.

The present invention also provides optical data storage media which enable optical writing, permanent writing, optical reading out, optical rewriting and protection against erasing or overwriting of information in the storage layer, and comprise
I) one or more transparent, optically clear, non-scattering, amorphous covering layers,
II) a composite film according to the invention such as is described above,
III) optionally a carrier of plastic in the form of at least one film of plastic or a composite film of plastic or a substrate of plastic.

The data storage medium according to the invention is preferably constructed as a holographic optical smart card. A storage card based on films of plastic which renders possible optical storage, reading and rewriting of information is called an optical smart card in the context of the invention. The smart card according to the invention achieves clear advances over current smart cards in terms of storage capacity, with a simultaneously reduced system complexity and extended functionality regarding personalization, document security/forgery protection.

The holographic images known from the market, called level 1 and level 2 security features, may be incorporated into the layer of a photoaddressable polymer. A level 1 security feature is understood as meaning a feature which serves for document or product security and is clearly recognizable with the naked eye without further aids. A level 2 security feature is understood as meaning a feature which is not directly visible but visible only via aids, such as lasers, UV lamps or microscopes.

Further security features, such as e.g. microscript, optical wave conductors with a decoupling signature and polarization images may also be realized via light exposure steps.

Optical methods for encoding data, in particular holographic hardware coding in the form of phase coding, intensity coding or polarization coding, are accessible via the layer according to the invention of a photoaddressable polymer.

The present invention also provides a process for the production of a composite film, wherein
A) the photoaddressable polymer is dissolved in a solvent,
B) the solution is applied to a substrate or to the transparent barrier layer or to the reflection layer, if present,
C) the solvent is evaporated and the composite film is dried.

The layers may be generated and shaped by spin coating, knife-coating, pouring, laminating, dipcoating, hot stamping, screen printing, spraying and high-pressure forming.

Preferably, the data storage medium is constructed as a multifunction card, an “optical smart card” in cheque card size. Smart cards are described in the international standards ISO 10373-1 and ISO 7810/7816. Reference is made to ISO 14443 and ISO 15376 for contactless smart cards.

Alternatively to these standards, person-related documents (identity cards, driving licences etc.) may also be realized.

Further embodiments are contactless security keys, in particular access cards (secure access cards) which fulfil the function of security keys, as well as optical storage cards (flash memory sticks or memory cards) for PC computers and portable multimedia equipment (MP3/4 players, TV players, digital cameras, mobile telephones, handheld computers etc.), as well as labels which may be made up independently for protection of products or brands, and furthermore labels for logistics purposes, e.g. the management of production processes or warehousing, and furthermore bank notes which include the data storage medium as a visible element.

The data storage media according to the invention meet all the basic requirements for permanent and/or reversible storage of data or security features. These include, in particular, the level of the light-induced birefringence, the high optical purity/quality as a basic prerequisite for an efficient holographic diffraction, the long-term stability of the light-induced birefringence during storage and during reading out, high lateral resolution of the polymeric layer, the possibility of generally rewriting digital or analogue data/information by direct overwriting of previous data or by erasing of previous data and subsequent writing, the possibility of generally fixing (in code or visibly) stored data/information for the purpose of data storage, i.e. protecting it against complete erasing and also protecting areas from being written on in the first instance, and no material shrinkage, which may lead to delamination or surface modification, which in turn may cause distortions or changes in contrast in the information images.

The storage layer may be applied to a film of plastic directly from a solution.

If required, the film of plastic may be metallized before application of the storage layer. This variant is suitable e.g. if aggressive solvents are employed for the PAP solution. In addition, especially if the metal layer is very thin, a barrier layer may be applied on to or underneath the metal layer. The layers are generated by means of known processes.

The main advantages of the data storage medium according to the invention are the high security level, which may be varied in stages, of the data storage medium and the potential of the data storage medium for a high storage capacity.

The data storage medium according to the invention is moreover distinguished by the following properties which are particularly relevant for use as a multifunction card:
Low complexity (transponder antenna e.g. may be dispensed with)
Design freedom in respect of the shape and size of the storage field
Design freedom in respect of the utilization of the storage area (various storage areas may be assigned by the user.)
Data of any type may be deposited in a holographic coded form
Scalable security
Identification elements may be written in by light
Multifunctionality by accessibility to the most diverse light exposure techniques, with the aid of which both grey value images and digital information as well as holographic coding are possible.

Particularly preferred compounds for PAP are, for example:

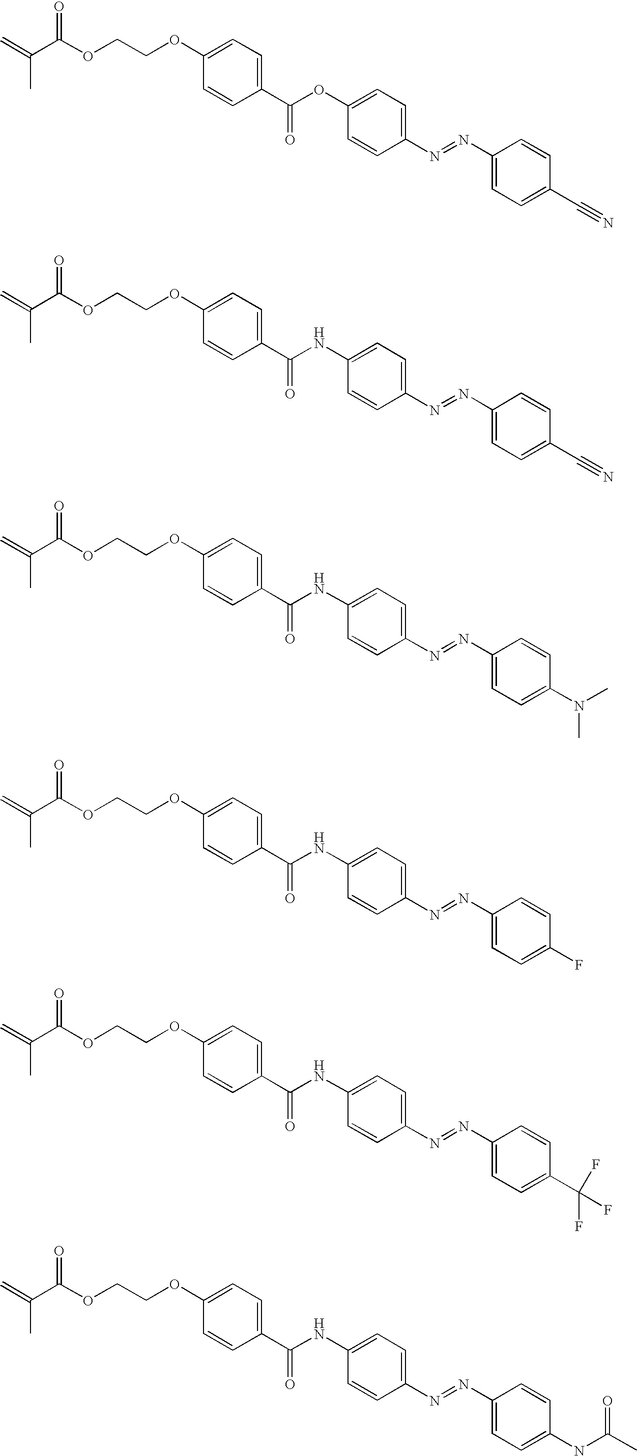

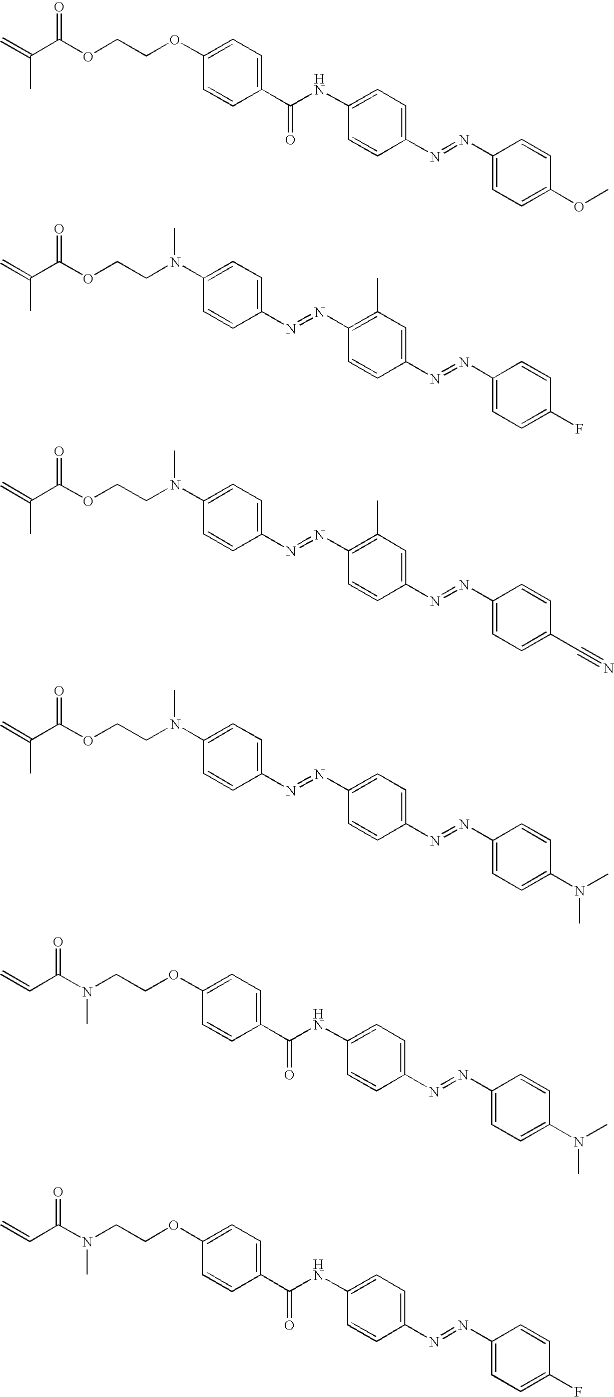

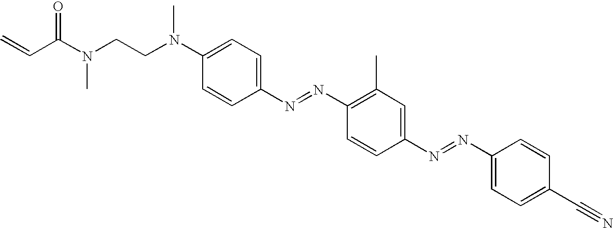

The polymeric or oligomeric organic, amorphous material (PAP) may carry, in addition to the structural units, for example of the formula (I), groupings (III) having form anisotropy. These are also bonded covalently to the polymer skeletons, via a spacer.

Groupings (structural units) having form anisotropy have, for example, the structure of the formula (III) 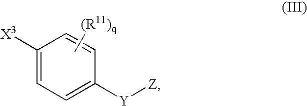
wherein
Z represents a radical of the formulae 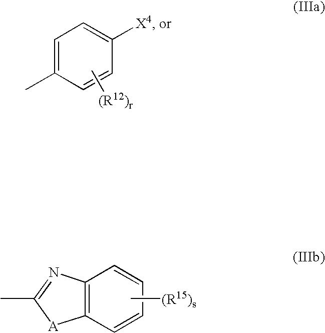
   wherein
A represents O, S or N—C₁- to C₄-alkyl,
X³ represents —X^{3′}-(Q²)ⱼ-T²-S²—,
X⁴ represents X^{4′}—R¹³,
X^{3′} and X^{4′} independently of one another represent a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)— or —(CNR⁸—NR⁵)—,
R⁵, R⁸ and R¹³ independently of one another represent hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or
X^{4′}—R¹³ can represent hydrogen, halogen, cyano, nitro, CF₃ or CCl₃,
R⁶ and R⁷ independently of one another represent hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,
Y represents a single bond, —COO—, —OCO—, —CONH—, —NHCO—, —CON(CH₃)—, —N(CH₃)CO—, —O—, —NH— or —N(CH₃)—,
R¹¹, R¹², R¹⁵ independently of one another represent hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—,
q, r and s independently of one another represent an integer from 0 to 4, preferably 0 to 2,
Q² represents —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)—, —(CNR⁸—NR⁵)—, —(CH₂)ₚ—, p- or m-C₆H₄— or a divalent radical of the formulae 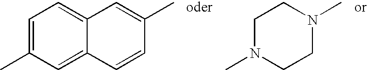
j represents an integer from 0 to 4, where for j>1 the individual Q² may have different meanings,
T² represents —(CH₂)ₚ—, wherein the chain may be interrupted by —O—, —NR⁹— or —OSiR¹⁰₂O—,
S² represents a direct bond, —O—, —S— or —NR⁹—,
p represents an integer from 2 to 12, preferably 2 to 8, in particular 2 to 4,
R⁹ represents hydrogen, methyl, ethyl or propyl,
R¹⁰ represents methyl or ethyl.

The groupings (III) having form anisotropy are preferably bonded to e.g. acrylates or methacrylates via so-called spacers and then have the structural unit based on the compounds of the formula (IV) 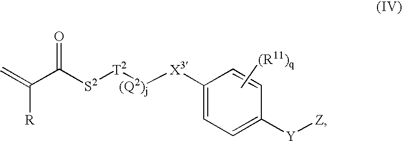
wherein
R represents hydrogen or methyl and
   the other radicals have the abovementioned meaning.

The alkyl, cycloalkyl, alkenyl and aryl radicals may in their turn be substituted by up to 3 radicals from the series consisting of halogen, cyano, nitro, C₁- to C₂₀-alkyl, C₁- to C₂₀-alkoxy, C₃- to C₁₀-cycloalkyl, C₂- to C₂₀-alkenyl or C₆- to C₁₀-aryl, and the alkyl and alkenyl radicals may be straight-chain or branched.

Halogen is to be understood as meaning fluorine, chlorine, bromine and iodine, in particular fluorine and chlorine.

Particularly preferred compounds of the formula (IV) with groups having form anisotropy are, for example:

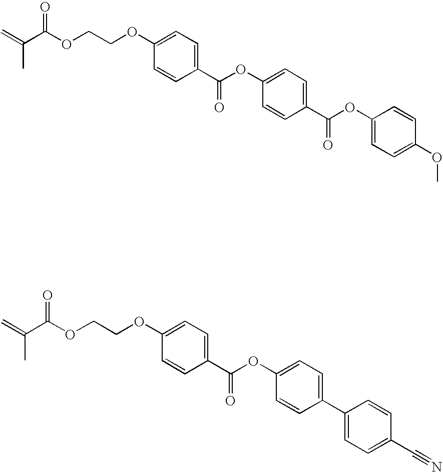

In addition to these functional units, the PAP may also comprise units which chiefly serve to lower the percentage content of functional units, in particular of dyestuff units. In addition to this task, they may also be responsible for other properties of the PAP, e.g. the glass transition temperature, liquid crystallinity, film-forming property etc.

For PAP based on polyacrylic or -methacrylic plastics, acrylic or methacrylic acid esters or amides of the formula (V) are preferred 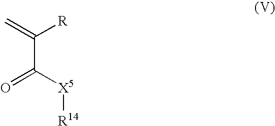
wherein
R represents hydrogen or methyl,
X⁵ represents —O— or —(N—R¹⁵)—,
R¹⁴ and R¹⁵ independently of one another represent optionally branched C₁- to C₂₀-alkyl or a radical containing at least one further acrylic unit, or together form a bridge member —(CH₂)_{f}—, —CH₂—CH₂—O—CH₂—CH₂— or —CH₂—CH₂—N(R)—CH₂—CH₂—, wherein
f represents 2 to 6.

Compounds of the formula (Va) 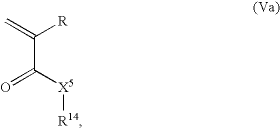
wherein
R represents hydrogen or methyl
X⁵ represents —(N—R¹⁵)— and
R¹⁴ and R¹⁵ have the meaning defined above
   are very particularly preferred.

The introduction of these monomer units imparts to the PAP the solubility in the typical solvents for CD-R and DVD-R production, such as e.g. 2,2,3,3-tetrafluoropropanol (TFP), via which the PAP may be applied directly to the substrate of plastic. The surface of the plastic (in particular of the polycarbonate) is not dissolved by this procedure.

In addition to the functional units of the formulae I and II, which are responsible for the storage of the optical information via the incident photophysically active light, the polymers may also comprise further units which carry dyestuffs of other classes which chiefly contribute towards the absorption of UV, VIS and IR external light, the wavelength spectrum of which does not overlap with the wavelength of the photophysically active light, e.g. of a so-called writing laser, and therefore protect the structural units I, II and III from external light in a manner such that the information stored is deposited in the storage layer in a more light-stable manner. However, other comonomers may also be present.

Particularly preferred PAP are, for example:
with x, y and p being 5-50 000, preferably 10-20 000 and x being 1 mol-% to 99 mol-% based on x and y and y being (100 mol-%−x)

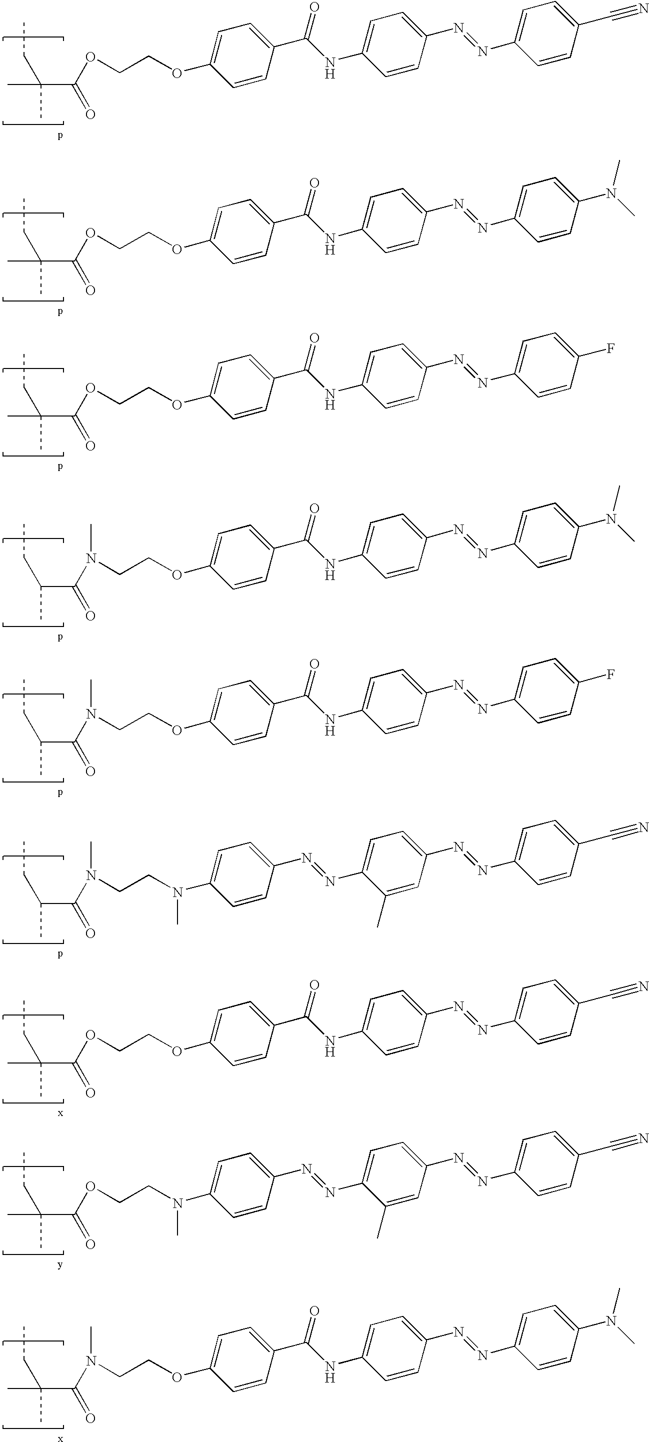

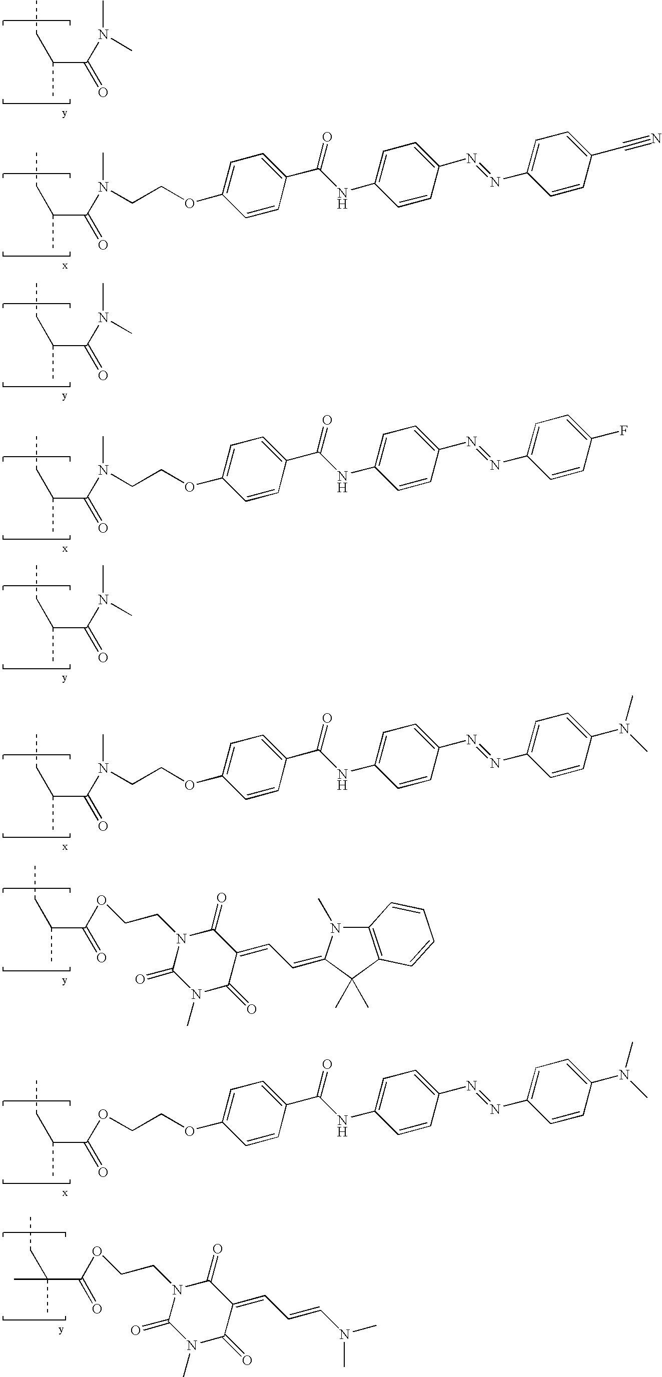

Preferably, the concentration of II is between 0.1 and 100%, based on the particular mixture. The ratio between II and IV is between 100:0 and 1:99, preferably between 100:0 and 20:80, very particularly preferably between 100:0 and 50:50.

The photoaddressable polymers (PAP) show very high light-induced changes in refractive index, the extent of which may be adjusted in a controlled manner via the light energy dose irradiated in. Birefringence values in the layer of preferably greater than 0.07 in the VIS spectral range, particularly preferably of greater than 0.1, very particularly preferably of greater than 0.15, may be achieved. It is thus possible to generate, by exposure to light, regions in a PAP layer which have a deviating refractive index, so that information of the most general nature may be deposited. i.e. may be stored permanently.

The PAP may be applied from the solution to a carrier (substrate layer), in particular to a carrier film, by known techniques, such as e.g. spin coating, spraying, knife coating, dipcoating etc. The layer thicknesses of the resulting films are typically between 10 nm and 50 μm, preferably between 30 nm and 5 μm, particularly preferably between 200 nm and 2 μm.

Depending on the desired method or methods for reading/reading out the information stored in the PAP film, the carrier film (substrate layer) is provided with a reflection layer, which has a reflectivity of at least 20%. In one embodiment, the reflection layer comprises a metal layer. Metals or metallic alloys, preferably aluminium, titanium, gold and silver, particularly preferably aluminium and silver, may be used.

The production takes place by known methods, such as electroplating, vapor deposition and sputtering.

Commercially available metallized thermoplastic films may also be used.

In a second embodiment, the reflection layer is distinctive as a multilayer structure in which the desired degree of reflection is achieved by controlled multiple reflections in its layered structure. The reflection layer is distinguished by an optical reflectivity of at least 20%. The average reflectivity in the visible (VIS) and near infra-red (NIR) spectral range is preferably at least 50%, preferably at least 80%, particularly preferably at least 90%.

Particularly thick metallic reflection layers (>300 nm) also serve to protect the carrier material from the solvents which are used during application of the photoaddressable polymers. This is important in the case where the solvent may superficially dissolve the material of the carrier film.

In order to prevent such superficial dissolving of the carrier film or, where appropriate, a detachment of the reflection layer, with some combinations of PAP solvents and carrier material one or more additional barrier layers may also be used as protection. These comprise polymeric materials or metallic oxides. A preferred embodiment is an amorphous, transparent polymer layer. Such layers may be produced from the solution by vapor deposition or by various CVD (chemical vapor deposition) processes, such as e.g. plasma polymerization, and are typically between 5 and 500 nm thick. Examples of barrier materials are polyethylene, partly crystalline PET, polysulfone, hydrogenated polystyrene and copolymers thereof with isoprene and butadiene.

A further variant for applying a protective layer to the carrier film is coextrusion, it being possible e.g. for a polysulfone layer to be applied to the polycarbonate film.

So-called protective lacquers are preferably used as covering layer(s) for the optical data storage medium. The protective lacquer may be employed for the following purposes: UV protection and protection from weathering, protection against scratching, mechanical protection, mechanical stability and heat stability. UV protection and protection against scratching are necessary in particular for the target use of smart card and ID card (pass).

The covering layer is preferably a lacquer which cures by radiation, preferably a UV-curing lacquer. UV-curing coatings are known and are described in the literature, e.g. P. K. T. Oldring (ed.), Chemistry & Technology of UV & EB Formulations For Coatings, Inks & Paints, vol. 2, 1991, SITA Technology, London, pp. 31-235. These are commercially obtainable as the pure material or as a mixture. Epoxide acrylates, urethane acrylates, polyester acrylates, acrylized polyacrylates, acrylized oils, silicon acrylates and amine-modified and non-amine-modified polyether acrylates for the basis of the material. In addition to acrylates or instead of acrylates, methacrylates may be used. Polymeric products which contain vinyl, vinyl ether, propenyl, allyl, maleyl, fumaryl, maleimides, dicyclopentadienyl and/or acrylamide groups as polymerizable components may furthermore be employed. Acrylates and methacrylates are preferred. Commercially obtainable photoinitiators may be present in amounts of 0.1 to approx. 10 wt. %, e.g. aromatic ketones or benzoin derivatives.

In a further embodiment, the covering layer comprises a film of plastic which is coated with the lacquer mentioned. The film of plastic is applied by pouring, knife-coating, spin coating, screen printing, spraying or laminating. The lacquer may be applied to the film of plastic before or after this process step.

The covering layer must fulfil the following properties: High transparency in the wavelength range of 750 to 300 nm, preferably of from 650 to 300 nm, low birefringence, non-scattering, amorphous, scratch-resistant, preferably measured in accordance with the pencil hardness test or other abrasion tests which are employed by card manufacturers, a viscosity preferably of from approx. 100 mPas to approx. 100,000 mPas.

Resins/lacquers which shrink only little during the exposure to light and have a weak double bond functionality and a relatively high molecular weight are particularly preferred. Particularly preferred material properties are therefore a double bond density below 3 mol/kg, a functionality of less than 3, very particularly preferably less than 2.5, and a molecular weight Mₙ of greater than 1,000, and very particularly preferably greater than 3,000 g/mol.

The liquid is applied by pouring, knife-coating or spin coating. The subsequent curing is carried out by exposure to light over a large area, preferably by exposure to UV light.

Such lacquer layers may also comprise UV absorbers for UV spectral ranges and light absorbers for various VIS spectral ranges (with the exception of the writing and reading wavelength used), such as e.g. polymerizable merocyanine dyestuffs (WO 2004/086390 A1, DE 103 13 173 A1) or nanoparticles.

The substrate layer has the task of a carrier for the data storage medium, imparting to it mechanical stability, or being necessary for further system integration, e.g. as an adhesive film. Acrylonitrile/butadiene/styrene (ABS), polycarbonate (PC), PC/ABS blends, polyethylene terephthalate (PET), polyethylene naphthalate (PEN), polyvinyl chloride (PVC), polymethyl methacrylate (PMMA), polyester (PE). polypropylene (PAP), cellulose or polyimide (PI) are suitable in particular as the material for the substrate layer. ABS, PVC, PE, PET, PC or blends of these materials are preferred. PC and all PC blends are particularly preferred.

The substrate layer is preferably formed as a film.

The optical requirements on barrier layers, covering layers and carrier materials result from the methods for writing information into the storage layer, for reading out and for fixing; the layers have to be transparent for the laser light which is used for reading and writing and have to be without influencing the polarisation.

Writing (in) means a light exposure process in which the wavelength or the wavelength range of the light overlaps with the absorption range of the PAP storage material according to the invention, so that the light becomes photophysically active and the desired photo-orientation processes take place at the molecular level.

The preferred wavelength range of the photophysically active light is between 380 nm and 568 nm, particularly preferably between 395 and 532 nm.

In the case of photographic exposure to light, laser light or lamp light is irradiated into the system in perpendicular incidence. In the case of interference light exposure, such as is used for holography, rays may also be incident at an angle. Holographic processes allow the exposure to light from one or at the same time from both sides of the data storage medium.

Depending on the light exposure geometries desired for the writing operation, the boundary layers of the storage layer must be transparent, distortion-free, achromatic and free from birefringence.

In the case of writing in from above, these requirements apply to the covering layer(s). For this light exposure geometry, the data storage medium as a rule has a reflection layer.

In the case of writing in from underneath, these requirements additionally apply to the carrier materials and to the barrier layers optionally present.

Reading (out) means the process which brings up the stored data again. Reading out takes place with the eye or a camera system as a detector, while light (daylight, artificial light, e.g. from semiconductor laser diodes, or laser light) is irradiated in at the site of the stored information, its wavelength or wavelength range preferably not overlapping with the absorption range of the PAP storage material according to the invention, so that the light does not become photophysically active.

The wavelength range of the reading light is in the visible (VIS) or near infra-red (NIR), preferably in the wavelength range of between 633 nm and 1350 nm, particularly preferably between 650 nm and 1200 nm.

The intensity of the reading light in the case of broad-band irradiation is typically less than 10 mW/(cm² nm), and in the case of narrow-band irradiation typically less than 10 mW/cm², preferably less than 1 mW/cm².

An irradiation in the absorption range of the storage layer does not lead to a change in the stored information provided that the duration chosen for the exposure to light is short enough and/or the light intensity chosen is low enough.

If the data is read out in reflection, the light source and detector/eye are on the same side of the data storage medium. The embodiment of the data storage medium which is preferred for this light exposure geometry has a reflection layer. The optical requirements mentioned apply in particular to the covering layer(s), as during the writing operation.

Reading out in transmission means that the exposure to light and observation/detection take place from two different sides. The optical requirements mentioned additionally apply in this case to the carrier material and, if present, also the barrier layer.

An embodiment of the data storage medium which is particularly preferred for this light exposure geometry has a recess in the carrier material, a so-called optical window, into which the composite film according to the invention is laid flush.

The present invention also provides a method for fixing written information. Fixing means protection against erasing by means of light or thermal energy.

Written information may be fixed by exposing the PAP film described to intensive UV/VIS light, such as is delivered e.g. by direct sunlight or a comparable light exposure apparatus (e.g. Atlas Suntester, 750 W/m², at the place of the stored information. PAP having structural units based on the compounds of the formula (II) wherein S¹ is —NR⁹— are particularly suitable for fixing written information.

The typical energy dose is 500 to 5,000 kJ/m².

Stabilization against accidental erasing is achieved by heat treatment of the composite film according to the invention described, at temperatures in the region of the glass transition temperature T_{g} or up to 70° C. above this, preferably in the temperature range of from T_{g} to T_{g}+30° C.

The invention is to be explained in more detail with the aid of the following examples.

### EXAMPLES

### Example 1

### Monomer Synthesis

1.1

47.6 g 4-aminoacetanilide were initially introduced into 200 ml water at 80° C. 20 ml 37% strength hydrochloric acid were added to this mixture and the mixture was stirred until dissolving was complete. This solution was cooled to 0° C. The remaining 230 ml 37% strength hydrochloric acid were then added slowly. 80.5 g sodium nitrite solution (30% strength in water) were added dropwise in the course of 45 min, while maintaining a temperature of 0-5° C. The mixture was subsequently stirred at 0-5° C. for 2 h.

38.4 g N,N-dimethylaniline were initially introduced into a mixture of 500 ml methanol and 250 ml water and the mixture was cooled to 10-15° C.

The diazonium salt solution was slowly added dropwise to this solution. A pH of 4-6 was maintained with 10% strength NaOH solution. The reaction mixture was subsequently stirred for 30 min. The precipitate was filtered off, washed with water on the filter and dried in vacuo. Purification was carried out by boiling up twice in toluene.

The yield of the product 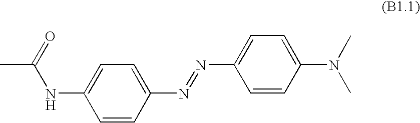
was 65 g.
1.2

50 g KOH were dissolved in 450 g ethanol. 25 g of substance B1.1 were added to this solution and the mixture was stirred under reflux for 3 h. This solution was cooled to room temperature and added to 1,000 ml water. The pH of the suspension was brought slowly to 10 with 10% strength hydrochloric acid. The precipitate was filtered off, washed with water on the filter and dried. Purification was by extracting twice by vigorous stirring in toluene at room temperature. The yield of the product 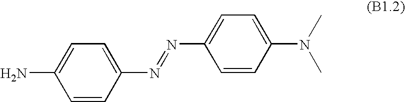
was 17 g.

Elemental analysis: C₁₄H₁₆N₄ (240.31) Calc.: C, 69.97; H, 6.71; N, 23.31. Found: C, 70.00; H, 6.70; N, 23.10.

1.3

107 g of substance B1.2 in 500 ml dioxane were added to a solution of 120 g 4-(2-methacryloyloxy-ethoxy)-benzoic acid chloride in 650 ml dioxane and the mixture was stirred at 60° C. for 2 h and cooled. The product was then precipitated by pouring the solution into 4 l water. The precipitate was filtered off, dried and purified by recrystallizing twice from dioxane. The yield of the product 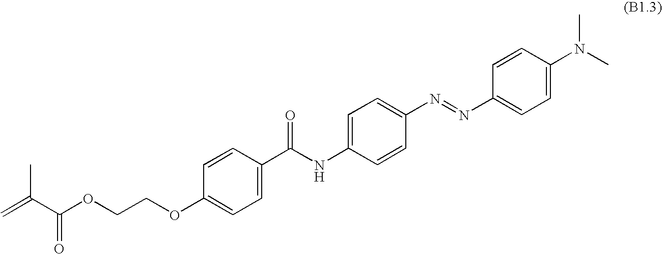
was 124 g.

Elemental analysis: C₂₇H₂₈N₄O₄ (472.55) Calc.: C, 68.63; H, 5.97; N, 11.86. Found: C, 68.10; H, 6.00; N, 1.40.

1.4

100 g B1.3 were dissolved in a solvent mixture of 200 ml dioxane, 100 ml methanol, 300 ml N-methylpyrrolidinone (NMP) and 16 ml water. 54 g of a 30% strength solution of sodium methylate in methanol and then 16 g water were added. The reaction mixture was stirred at room temperature for 3 h and then added to 3,000 ml water. The precipitate was collected on a filter and dried. The yield of the product 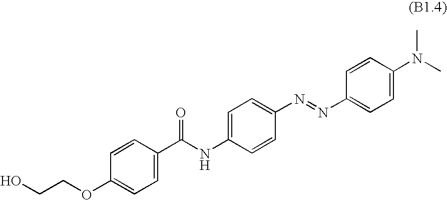
was 100 g.

Elemental analysis: C₂₃H₂₄N₄O₃ (404.47) Calc.: C, 68.30; H, 5.98; N, 3.85. Found: C, 67.50; H, 5.90; N, 13.60.

1.5

72 g B1.4 were dissolved in a mixture of 660 g pyridine and 150 ml N-methylpyrrolidinone (NMP) at 60° C. The solution was cooled to room temperature. 68 g p-toluenesulfonic acid chloride were added in portions. The reaction mixture was stirred at room temperature for 24 h. The reaction mixture was introduced into water. The precipitate was filtered off, washed with water and methanol on the filter and dried in vacuo at 50° C. Purification was carried out by absorptive filtration through 10 cm of a silica gel layer in cyclopentanone. The filtrate was concentrated on a rotary evaporator. The crystals were dried in vacuo at 50° C. The yield of the product 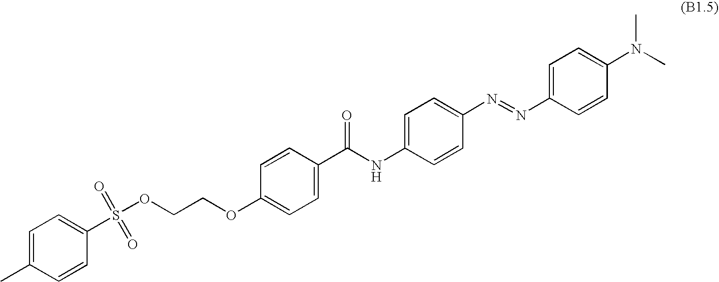
was 30 g.
1.6

5.4 g B1.5 were dissolved in 20 g N-methylpyrrolidinone (NMP). 5 g Na₂CO₃ (anhydrous) and 9.1 g 33% strength methylamine solution in ethanol were added. The reaction mixture was stirred at 70° C. for 3 h. The reaction mixture was introduced into water. The precipitate was filtered off and dried in vacuo. Purification was carried out by chromatography on silica gel in dioxane/ethanol (2:1). The yield of the product 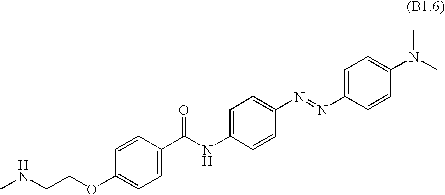
was 2 g.

Elemental analysis: C₂₄H₂₇N₅O₂ (417.52) Calc.: C, 69.04; H, 6.52; N, 16.77. Found: C, 68.60; H, 6.50; N, 16.30.

1.7

Solutions of 36.6 g B1.6 in 250 ml N-methylpyrrolidinone (NMP) and 15.9 g acrylic acid chloride in 36 ml NMP were combined, heated up to 70° C. and stirred for 1 h. The reaction mixture was added to a solution of 92 g sodium carbonate in 3,700 ml water and the mixture was stirred for 30 min. The precipitate was filtered off and dried. Purification was carried out by chromatography on silica gel in cyclopentanone. The yield of the product 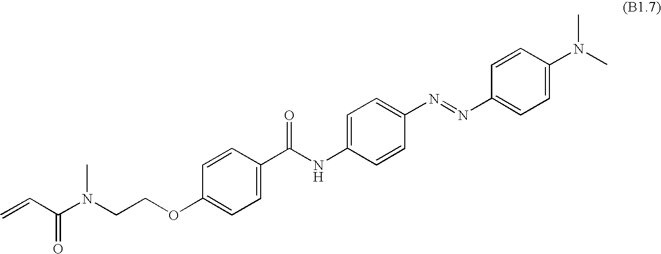
was 9 g.

Melting point=222° C.

Elemental analysis: C₂₇H₂₉N₅O₃ (471.56) Calc.: C, 68.77; H, 6.20; N, 14.85. Found: C, 68.20; H, 6.20; N, 14.00.

1.8

a) Diazotization

400 ml water and 70.5 g 4-fluoroaniline were initially introduced into the reaction vessel at 60° C. 40 ml 37% strength hydrochloric acid were added to this suspension and the mixture was stirred until dissolving was complete. The solution was cooled to 0° C. and 460 ml 37% strength hydrochloric acid were added slowly. The hydrochloride of 4-fluoroaniline settled out in the form of a paste. 161 g sodium nitrite solution (30% strength in water) were added dropwise in the course of 45 min, while maintaining a temperature of 0-5° C. The mixture was subsequently stirred at 0-5° C. for 2 h. A clear solution was formed.

b) Preparation of the Coupling Component

178 ml sodium hydrogen sulfite solution (37% strength) and 70 ml formaldehyde solution (37% strength) were initially introduced into the reaction vessel at 60° C. 59.6 g aniline were added at this temperature and the mixture was subsequently stirred for 2 h. The reaction mixture was now transferred into a stirred apparatus. 2,000 ml water were added to the reaction mixture and the mixture was subsequently stirred again at 60° C. for 30 min. A clear colourless solution was formed. It was cooled to 10-15° C. by external cooling.

c) Coupling

The above diazonium salt solution was transferred into a metering funnel. The diazonium salt solution was allowed to run slowly into the solution of the above coupling component, while maintaining a temperature of 10-20° C. During the addition of the diazonium salt solution, approx. 2,500 ml sodium hydroxide solution (10% strength) were slowly added dropwise, in order to keep the pH between 5 and 6. The reaction mixture was subsequently stirred for 30 min. The precipitate was filtered off and prepared for splitting off of the protective group while still moist.

d) Splitting Off of the Protective Group

The still moist product from e) was added to 2,000 ml sodium hydroxide solution (20% strength) and the mixture was stirred overnight at 40° C. Approx. 2.0-2.51 hydrochloric acid were slowly added, while cooling with an ice bath, in order to achieve a pH of 10-10.3.

The mixture was subsequently stirred briefly (approx. 30 min). The precipitate was filtered off with suction over a large suction filter and rinsed with water and the residue was dried in a vacuum drying cabinet at 50° C. until completely dry.

e) Purification of the Product

The crude product from d) was boiled up in a mixture of toluene and ethyl acetate (4:1). The solution was filtered off from undissolved substance and cooled, and passed through a column with silica gel. The solvent was removed from the relevant fractions on a rotary evaporator. The substance was dried in vacuo. The yield of the product 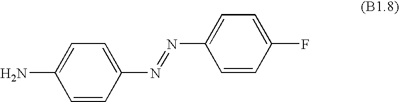
was 23 g.
1.9

Analogously to 1.8, a synthesis was carried out with 75 g 4-cyanoaniline as the diazotization component. The crude product was boiled up in 750 ml dioxane. The solution was filtered off from undissolved substance and cooled, and passed through a 10-15 cm high column with Al₂O₃. The solvent was removed from the solution running through using a rotary evaporator. The substance was dried in vacuo. The yield of the product 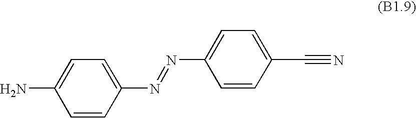
was 97 g.

Melting point=194° C. Elemental analysis: C₁₃H₁₀N₄ (222.25) Calc.: C, 70.26; H, 4.54; N, 25.21. Found: C, 70.30; H, 4.40; N, 24.40.

1.10

Analogously to 1.8, a synthesis was carried out, 75 g 4-cyanoaniline being used as the diazotization component and 68 g o-toluidine being used for the coupling component. The yield of the product 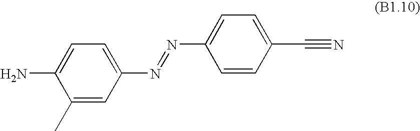
was 110 g.
1.11

From 9.0 g B1.8, the synthesis of the product 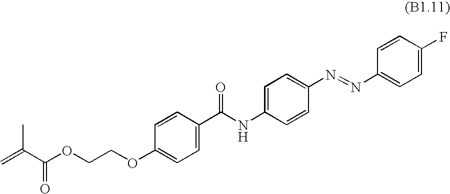
was carried out analogously to Example 1.3. Purification was carried out by absorptive filtration through a 10 cm layer of Al₂O₃ in dioxane and subsequent crystallization from dioxane. The yield was 7.9 g.

Elemental analysis: C₂H₂₂FN₃O₄ (447.47) Calc.: C, 67.11; H, 4.96; F 4.25; N, 9.39. Found: C, 67.00; H, 4.90; F 4.40; N, 9.50.

1.12

From 64 g B1.8, the synthesis of the product 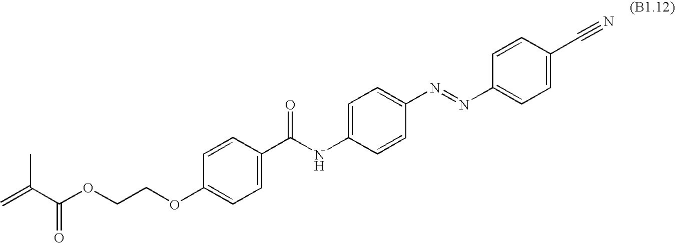
was carried out analogously to Example 1.3. Purification was carried out by absorptive filtration through a 10 cm layer of Al₂O₃ in dioxane and subsequent crystallization from dioxane. The yield was 97 g.

The substance showed the following phase transitions: melting point=174° C.; liquid crystal phase up to 204° C.

1.13

11 g acrylic acid chloride in 100 ml dioxane were added to a solution of 10 g N-methyl-N-(2-methylamino-ethyl)-aniline in 30 ml dioxane and the mixture was stirred at 90° C. for 24 h and cooled. The solvent was removed from the reaction mixture on a rotary evaporator. Purification was carried out by chromatography on silica gel in toluene/ethyl acetate (1:2). The yield of the product 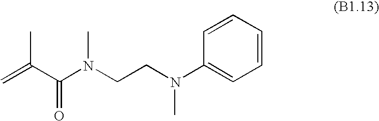
was 5.5 g.
1.14

5.4 g B1.10 were dissolved in 40 ml glacial acetic acid and 15 ml hydrochloric acid (37% strength), while heating, and the solution was cooled to 0° C. 9 g sodium nitrite solution (30% strength in water) were added dropwise, while maintaining a temperature of 0-5° C. The mixture was subsequently stirred at 0-5° C. for 1 h.

5.1 g B1.13 were initially introduced into 170 ml isopropanol. The diazonium salt solution was transferred into a metering funnel. The diazonium salt solution was now added slowly, while maintaining a temperature of 10° C. and with the simultaneous addition of up to approx. 30 ml 20% strength sodium acetate solution in water. The mixture was subsequently stirred for 1 h. The reaction mixture was poured into 1 l water. The product was taken up in methylene chloride. The solution was separated off from the aqueous phase and dried with magnesium sulfate. The solvent was removed from the solution on a rotary evaporator. Purification was carried out by chromatography on silica gel in toluene/ethyl acetate (1:2).

The yield of the product 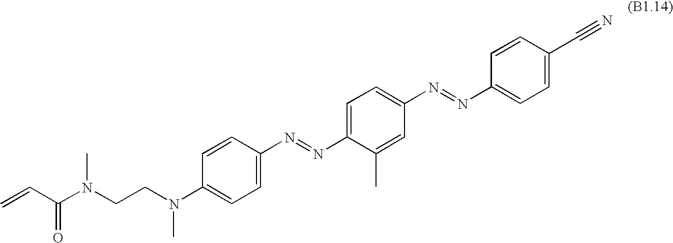
was 1 g.

Melting point=118° C. Elemental analysis: C₂₇H₂₇N₇O (465.56) Calc.: C, 69.66; H, 5.85; N, 21.06. Found: C, 68.00; H, 5.90; N, 19.90.

### Example 2

### Polymer Synthesis

2.1

15.0 g monomer B 1.12 were dissolved in 140 ml N,N-dimethylformamide (DMF) at 70° C. After the monomer had dissolved, the apparatus was flushed with argon for a further half an hour, 0.75 g 2,2′-azoisobutyric acid dinitrile in 5.0 ml DMF were then added and this solution was stirred under a flow of argon for two days. The reaction mixture was cooled to room temperature and filtered through a fluted filter. DMF was removed completely from the solution on a rotary evaporator. The residue was boiled up under reflux in 100 ml methanol for half an hour. The methanol solution was then poured off from the precipitate. This operation was repeated twice more. The finished product 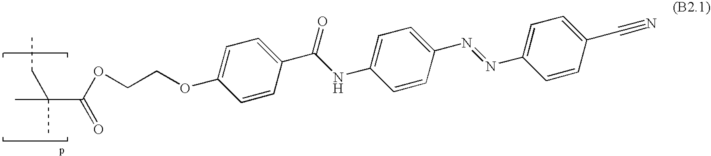
was dried in vacuo. Yield: 13.4 g.
2.2

From 15 g of monomer B 1.3, the synthesis of the polymer 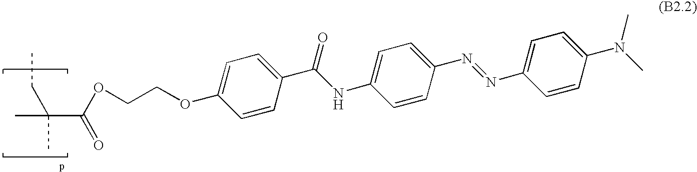
was carried out analogously to Example 2.1. The yield was 14.3 g.
2.3

From 5 g of monomer B 1.10, the synthesis of the polymer 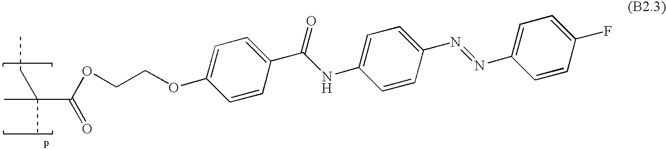
was carried out analogously to Example 2.1. The yield was 4.7 g.
2.4

From 1.3 g of monomer B 1.7, the synthesis of the polymer 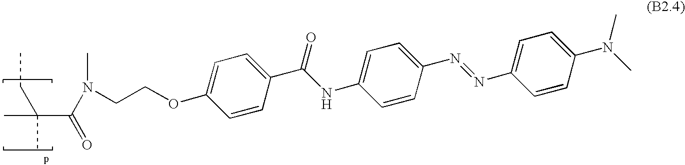
was carried out analogously to Example 2.1. Purification of the polymer was carried out by boiling up three times in toluene. The yield was 1.0 g.
2.5

From 0.6 g of monomer B 1.14, the synthesis of the polymer 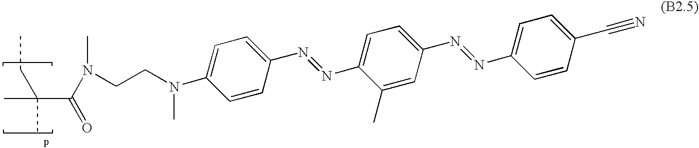
was carried out analogously to Example 2.4. The yield was 0.3 g.
2.6

From a mixture of 5 g of monomer B1.12 and 0.57 g of monomer B2.6a 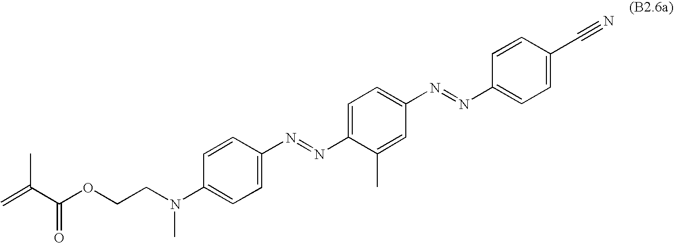
the copolymer 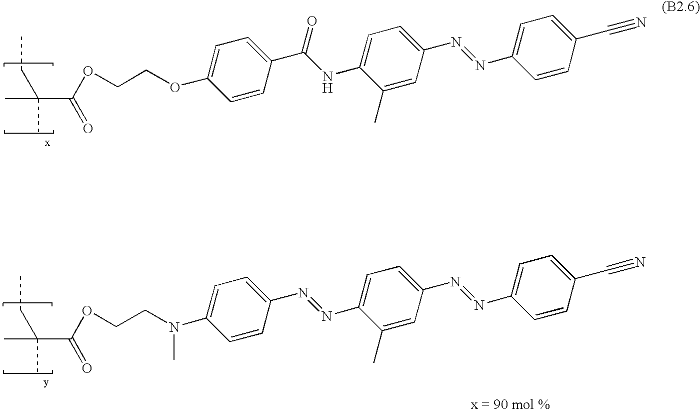
was prepared analogously to Example 2.1. The yield was 4.7 g.
2.7

From a mixture of 5 g of monomer B1.3 and 0.45 g or 0.7 g N,N-dimethylacrylamide, the copolymers 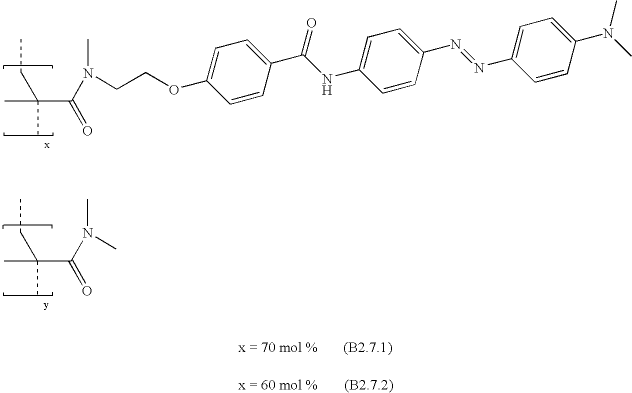
were prepared analogously to Example 2.4. The yield was 4.9 g and 4.8 g respectively.
2.8

From a mixture of 1.5 g of monomer B1.14 and 0.137 g N,N-dimethylacrylamide, the copolymer 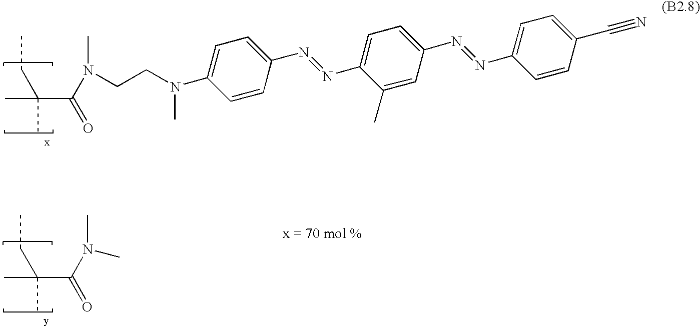
was prepared analogously to Example 2.4. The yield was 1.12 g.
2.9

From a mixture of 1 g of monomer B1.7 and 0.1 g of monomer B2.9a 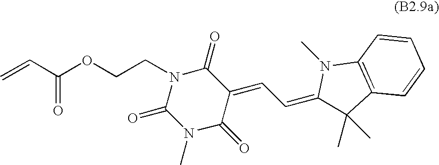
the copolymer 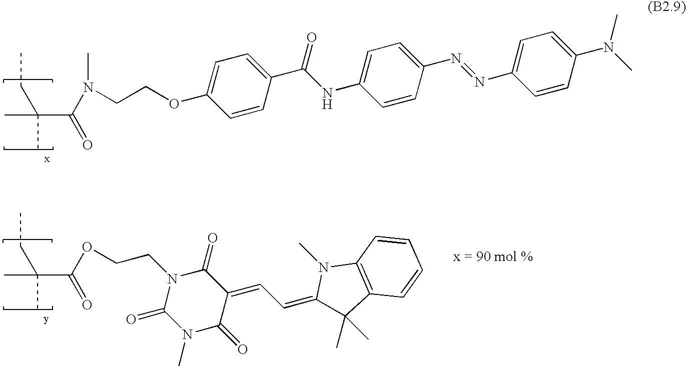
was prepared analogously to Example 2.4. The yield was 0.85 g.
2.10

From a mixture of 2 g of monomer B1.3 and 1.42 g of monomer B2.10a 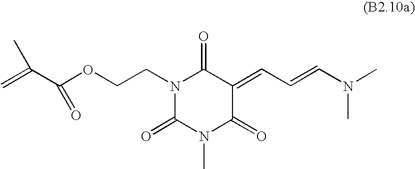
the copolymer 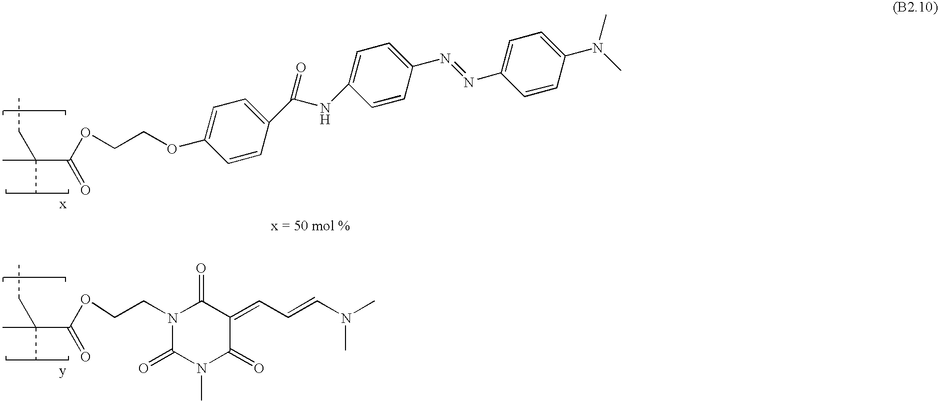
was prepared analogously to Example 2.4. The yield was 3.0 g.

### Example 3

### Preparation of the Polymer Solutions

3.1

15.0 g of polymer B2.1 were dissolved in 100 ml cyclopentanone at 70° C. The solution was cooled to room temperature and filtered through a 0.45 μm and then through a 0.2 μm Teflon filter. The solution remained stable at room temperature and was used for application of polymer B2.1 to various surfaces, such as e.g. to polymeric surfaces and to metallized polymer surfaces.

3.2

Analogously to Example 3.1, a solution of 15.0 g of polymer B2.2 in 100 ml cyclopentanone was prepared.

3.3

Analogously to Example 3.1, a solution of 15.0 g of polymer B2.3 in 100 ml cyclopentanone was prepared.

3.4

Analogously to Example 3.1, a solution of 15.0 g of polymer B2.4 in 100 ml cyclopentanone was prepared.

3.5

Analogously to Example 3.1, a solution of 15.0 g of polymer B2.5 in 100 ml cyclopentanone was prepared.

3.6

Analogously to Example 3.1, a solution of 15.0 g of polymer B2.6 in 100 ml cyclopentanone was prepared.

3.7

Analogously to Example 3.1, a solution of 15.0 g of polymer B2.9 in 100 ml cyclopentanone was prepared.

3.8

15.0 g of polymer B2.1 were dissolved in 100 ml of a mixture of 35 wt. % cyclopentanone and 65 wt. % 2-methoxyethanol at 70° C. The solution was cooled to room temperature and filtered through a 0.45 μm and then through a 0.2 μm Teflon filter. The solution remained stable at room temperature and was used for application of the polymer B2.1 to various surfaces, such as e.g. to polymeric surfaces and to metallized polymer surfaces.

3.9

Analogously to Example 3.8, the solution of 15.0 g of polymer B2.6 in 100 ml of a mixture of 35 wt. % cyclopentanone and 65 wt. % 2-methoxyethanol was prepared.

3.10

15.0 g of polymer B2.4 were dissolved in 100 ml 2,2,3,3-tetrafluoropropanol (TFP) at 100° C. The solution remained stable up to 80° C., and on further cooling the polymer precipitated out. The analogous polymer based on polymethacrylate (B2.2) did not dissolve in TFP.

3.11

15.0 g of polymer B2.4 were dissolved in 100 ml 2,2,3,3-tetrafluoropropanol (TFP) at 100° C. The solution remained stable up to 90° C., and on further cooling the polymer precipitated out. The analogous polymer based on polymethacrylate did not dissolve in TFP.

3.12

15.0 g of polymer B2.7.1 were dissolved in 100 ml 2,2,3,3-tetrafluoropropanol (TFP) at 70° C. The solution was cooled to 40° C. and filtered through a 0.45 μm and then through a 0.2 μm Teflon filter. The solution remained stable at room temperature for several hours, and was used for application of polymer B2.7.1 to various surfaces, such as e.g. to polymeric surfaces and to metallized polymer surfaces. On standing for a relatively long time, a gel formed at room temperature, which it was possible to dissolve again on heating.

3.13

15.0 g of polymer B2.7.2 were dissolved in 100 ml 2,2,3,3-tetrafluoropropanol (TFP) at 70° C. The solution was cooled to room temperature and filtered through a 0.45 μm and then through a 0.2 μm Teflon filter. The solution remained stable at room temperature and was used for application of polymer B2.7.2 to various surfaces, such as e.g. to polymeric surfaces and to metallized polymer surfaces.

3.14

Analogously to Example 3.13, a solution of 15.0 g of polymer B2.10 in 100 ml 2,2,3,3-tetrafluoropropanol (TFP) was prepared.

### Example 4

### Coating of Surfaces of Glass and Plastic with Photoaddressable Polymers

4.1 Coating of Glass Substrates

Coating of glass substrates 1 mm thick was carried out with the aid of the spin coating technique. A “Karl Süss CT 60” spin coater was used. A square glass carrier (26×26 mm) was fixed on the rotating platform of the apparatus, covered with solution 3.1 and rotated for a certain time. Depending on the rotating program of the apparatus (acceleration, speed of rotation and rotating time), transparent, amorphous coatings of optical quality 0.2 to 2.0 μm thick were obtained. Residues of the solvent were removed from the coatings by storage of the coated glass carrier for 24 h at room temperature in a vacuum cabinet.

4.2 Direct Coating of Polycarbonate Films

Direct coating of polycarbonate films (PC film e.g. Makrofol® film from Bayer MaterialScience) is now possible from certain solvents. The solvents should not superficially dissolve polycarbonate (PC) and damage the surface of the film in this way. 2,2,3,3-Tetrafluoropropanol (TFP) was used as the solvent. Only photoaddressable polymers which are soluble in TFP are possible for direct coating of the polycarbonate.

Pieces of film stamped out beforehand (e.g. length 85.725 mm; width 53.975 mm) were used for the coating. The thickness of the PC film varied from 75 to 750 μm. A piece of film was fixed on the rotating platform of the abovementioned apparatus, covered with solution 3.13 and rotated for a certain time. Depending on the rotating program of the apparatus (acceleration, speed of rotation and rotating time), transparent, amorphous coatings of optical quality 0.2 to 2.0 μm thick were obtained. Residues of the solvent were removed from the coatings by storage of the coated pieces of PC film for 24 h at room temperature in a vacuum cabinet.

Square pieces of film 10×10 cm in size were coated analogously, and from these pieces of cheque card size and in other formats (e.g. strips: length 85.725 mm; width 5.54 mm) were then stamped out and used later for card production.

4.3 Coating of Metallized Polycarbonate Films

4.3.1 Metallization of PC Films

Silver was used as the reflection layer and was applied by means of magnetron sputtering. The Ar pressure during the coating was 5×10⁻³ mbar. Sputtering was carried out with a power density of 1.3 W/cm². The layer thickness was measured with an Alphastep 500 mechanical profilometer (Tencor). The thickness was adjusted to between 100 and 400 nm.

4.3.2 Application of Photoaddressable Polymers Directly to a Metal Coating Having a Thickness of Less than 300 nm

The metal coatings on polycarbonate films, the thickness of which is between 50 and 300 nm, indeed offer mirror properties which are adequate for optical or holographic storage, but do not have adequate barrier functions against aggressive solvents. Cyclopentanone e.g. attacks the polycarbonate through the numerous microdefects in these metal coatings, which leads to a marked reduction in the optical quality of the storage layer. In this case, only solutions in 2,2,3,3-tetrafluoropropanol (TFP) were employed. Coating was carried out analogously to Example B4.1 on the metallized surface of the PC film.

4.3.3 Application of Photoaddressable Polymers to a Metal Coating Having a Thickness of Less than 300 nm, a Thin Polymeric Barrier Layer being Applied to the Metal Layer Beforehand

In order to be able to apply photoaddressable polymers based on polymethacrylate, which do not dissolve in TFP but dissolve only in cyclopentanone or in cyclopentanone-containing mixtures, on thinly metallized polycarbonate films, the metallization must be coated beforehand with a thin so-called polymeric barrier layer which is resistant to such solvents. This barrier layer must be optically clear, transparent and free from birefringence, in order not to influence optical storage and reading processes. Hydrogenated polystyrenes and hydrogenated polystyrene/polyisoprene copolymers (U.S. Pat. No. 6,492,468) have these properties.

The barrier layer was produced in the following manner: 1 g of hydrogenated triblock copolymer having a total content of vinylcyclohexane units of 90 mol % (U.S. Pat. No. 6,492,468) were dissolved in 9 g n-heptane. The solution was filtered through a 0.45 μm and then through a 0.2 μm Teflon filter. The solution was brought on to the metallized PC film by means of the spin coating process (see Example 4.2). Depending on the rotating program of the apparatus (acceleration, speed of rotation and rotating time), colourless, transparent, amorphous coatings of optical quality 0.05 to 0.2 μm thick were formed by this procedure. Residues of the solvent were removed from the coatings by storage of the PC films coated in this way for 24 h at room temperature in a vacuum cabinet. Subsequent coating with photoaddressable polymers was carried out from solutions B3.8 and B3.9 analogously to Example 4.2. Depending on the rotating program of the apparatus (acceleration, speed of rotation and rotating time), transparent, amorphous coatings of optical quality 0.2 to 2.0 μm thick were obtained.

4.3.4 Application of Photoaddressable Polymers to a Metal Coating Having a Thickness of More than 300 nm

Direct coating of metallized PC films on which the metal layer is thicker than 300 nm with photoaddressable polymers from aggressive solvents, such as cyclopentanone, is possible.

The photoaddressable polymers were applied directly to the metallized PC films analogously to Example B4.1 from solutions B3.1 to B3.7. Depending on the rotating program of the apparatus (acceleration, speed of rotation and rotating time), transparent, amorphous coatings of optical quality 0.2 to 2.0 μm thick were obtained.

4.4 Coating of Coextruded Films of Polycarbonate/Polysulfone (PC/PSU)

4.4.1 Metallization of the PC/PSU Film on the PSU Side

The metallization was carried out in accordance with Example 4.3.1.

4.4.2 Application of Photoaddressable Polymers to the Polysulfone Side of the PC/PSU Coextruded Films and to Metallized Coextruded Films

The polysulfone side of the film or the metallized polysulfone side of the film was coated with photoaddressable polymers from solutions B3.1 to B3.7 by means of spin coating analogously to Example B4.2.

Coating with photoaddressable polymers was also carried out with solutions according to Examples 3.12 to 3.14.

4.5 Coating of Metallized Polycarbonate Films by Knife-Coating

A 750 μm thick polycarbonate film metallized with a silver layer was coated with polymer B2.7.2. A 50 μm thick layer of solution B3.13 having a concentration of 150 g of polymer per 1,000 ml of solvent was applied uniformly to the metallized film by knife-coating. After drying in vacuo, a coating 4.07 μm thick resulted. At a dilution of the solution to 70 g per 1,000 ml, a coating 1.65 μm thick resulted. Further dilutions resulted in the following layer thicknesses: 60 g per 1,000 ml: 1.50 μm; 50 g per 1,000 ml: 1.08 μm; 30 g per 1,000 ml: 0.53 μm layer thickness.

### Example 5

### Production of a Data Carrier/a Card

The films of plastic coated with photoaddressable polymers, according to Example 4, were coated or covered with films on the PAP side and optionally additionally on the side of the film of plastic. These coatings/films improve the mechanical resistance and protect the information layer from mechanical and other (heat, light, moisture) influences. The layers may be applied by vacuum coating, lacquering or laminating.

5.1 Covering of the Photoaddressable Polymer Layer with Silicon Oxide

A silicon oxide coating was applied as an outer protective layer. SiO₂ particles having a diameter of about 200 nm were deposited as a transparent protective layer on the PAP layer of the film from Example 4.2 by means of an electron beam vaporizer. The power of the electron beam in this procedure was 1.5 kW and the process was carried out under a high vacuum under a pressure of 5×10⁻⁷ mbar.

5.2 Application of a UV-Curing Lacquer

A layer of a UV-curing lacquer was additionally applied to the silicon oxide coating from Example 5.1. The lacquer layer was applied by spin coating analogously to Example 4.2 in the form of a DVD adhesive “DAICURE CLEAR SD-645” from DIC Europe GmbH and was cured by exposure to UV light (90 watt; 312 nm). By appropriate adjustment of the rotating program of the spin coater (acceleration, speed of rotation and rotating time), transparent, amorphous coatings 50 μm thick of optical quality were obtained. The coatings could be adjusted to a thickness of from 1 to 100 μm, depending on the rotating program of the spin coater.

5.3 Lamination (Protection of the Pap Layer by Means of Polycarbonate Film)

The PAP-coated coextruded films (PC/PSU films) produced according to Example 4.4 were laminated with a structured or smooth polycarbonate film in a hydraulic hot press from Burkle, type LA 62, the PAP layer being covered by the polycarbonate film. The lamination was carried out between two polished high-grade steel plates (mirror sheet metal) and a pressure compensation bed (pressing cushion). The lamination parameters (temperature, time, pressure) were adjusted such that the PAP coating showed no visible damage and the card blank showed no flatness defects.

Card construction:

Protective layer: polycarbonate film 50 μm
Inlay: PC/PSU/Al/PAP*approx. 250 μm
Polycarbonate film coloured white approx. 500 μm
   (*Size of the inlay comparable to that of a magnetic strip in a card)
   Card Blanks for the Coating

The PC/PSU/Al samples were laid in a hydraulic hot press (manufacturer Bürkle) in single-use construction (one layer per lamination operation) with the vapor-deposited side to the mirror sheet metal. The lamination was carried out between two polished high-grade steel plates and a pressure compensation bed (pressing cushion). The lamination parameters (temperature, time, pressure) were adjusted such that the aluminium coating showed no visible damage and the card blank showed no flatness defects.

Card construction: Protective layer:

vapor-deposited polycarbonate/polysulfone coextruded film PC/PSU/Al
Polycarbonate film white and transparent approx. 500 μm.

### Example 6

### Measurement of the Holographic Properties

The course of the diffraction efficiency with respect to time during the holographic light exposure was determined on a photoaddressable polymer (PAP) of structure (B2.2) for various polarization states. The so-called holographic growth curves were evaluated in respect of the diffraction efficiencies achieved and the polarization state with which the highest efficiency may be achieved was determined.

Coating of the carrier film with a photoaddressable polymer (B2.2) was carried out in accordance with Example 4. The thickness of the PAP layer was approx. 1.6 μm.

Instead of the metal layer, the PC/PSU carrier films were provided with a barrier layer of hydrogenated polystyrene in accordance with Example 4.3.3, in order to be able to read out the data carrier in transmission.

The carrier films coated in this way were covered with films according to Example 5 on the PAP side and additionally on the side of the film of plastic.

Card structure:

Protective layer: polycarbonate film 50 μm
Inlay: PC/PSU/hydrogenated polystyrene/PAP approx. 250 μm
Polycarbonate film approx. 500 μm

The specimens were exposed to light from a frequency-doubled neodymium-YAG laser at a wavelength of λ=532 mm. Two flat waves which were overlapped on the specimen under an angle of 40° were generated by this means. For this, the laser beam was extended to a diameter of approx. 30 mm and collimated.

A metal diaphragm of 6 mm diameter was used to limit the area exposed to light and therefore the introduction of energy into the specimen.

The various polarizations of the exposing light beams were established by the use of λ/2 and λ/4 delay platelets.

The diffraction efficiency was measured during the exposure to light with an HeNe laser at λ=633 nm and recorded. Measurements were carried out for the following polarizations: circular (counter-clockwise), linear parallel, linear under 45°, linear under 90°. In the case of circular exposure to light, the behaviour was moreover investigated for various energy densities.

For all the polarizations, a measurement series with 5 to 10 specimens was exposed to light. The evaluation shows the mean and the maximum of all the specimens. The diffraction efficiency is stated in % with respect to the light exposure time in seconds at a given power density of 100 mW/cm².

| Polarization | Values after 100 s | Saturation values |
|---|---|---|
| Counter-clockwise circular | 16%/20% | 52%/57% after 600 s |
| Linear parallel | 3% | 7%/8% after 350 s |
| Linear 45° | 5%/7% | 22%/28% after 600 s |
| Linear 90° | 3%/4% | 16%/20% after 700 s |

Results:

The holographic gratings generated behaved differently, depending on the polarization of the light. All the polarizations tested led to holographic diffraction. Counter-clockwise circular polarization is preferred, because it produced the highest diffraction efficiencies.

When measured on other holographic films, PAP show high diffraction efficiencies even with very thin layer thicknesses of approx. 1.6 μm.

The effects observed may be used in polarization optics.

### Example 7

### Determination of the Light-Induced Birefringence of Photoaddressable Polymers

Specimens according to Example 6 were produced on the basis of the PAP B2.1-B2.10. The specimens prepared in this way were irradiated with polarized laser light in perpendicular incidence from the polymer side (writing operation). A Verdi laser (Coherent) having a wavelength of 532 nm served as the light source. The intensity of this laser was 1,000 mW/cm². trans-cis-trans isomerization cycles were induced in the side group molecules of the polymers, which led to a build-up of a net orientation of the molecules away from the polarization direction of the laser. These molecular dynamics manifested themselves macroscopically in a developing birefringence Δn=n_{y}−nₓ in the plane of the polymer film. The refractive index in the direction of the polarization of the laser light (nₓ) dropped during this process, while the refractive index perpendicular to the polarization direction (n_{y}) increased. The dynamics proceeded in the region of minutes at the given light exposure parameters.

The course of the induced birefringence with respect to time at a wavelength of 633 nm was determined experimentally with a helium-neon laser (typical intensity: 10 mW/cm²). This operation is called reading out of the birefringence. The incident light of this laser (so-called reading laser) on the polymer layer occupied a fixed angle of between 15° and 35° to the normal of the layer. Reading and writing light overlapped on the polymer layer. The polarization direction of the reading light occupied an angle of 45° to the polarization of the writing light in the plane of the polymer film. It was rotated on passing through the polymer layer if the layer was birefringent. This rotation was accompanied by an increase in the reading light intensity Iₛ according to an analyzer which stood in the beam path after the specimen and allowed light through perpendicular to the original polarization direction. To the same extent as Iₛ increased, the intensity Iₚ decreased. Iₚ is defined as the transmitted intensity after an analyzer which is positioned just so but which selects the original polarization direction of the reading laser. The two contents of the polarization direction parallel and perpendicular to the original direction were separated via a polarizing beam divider and detected with the aid of two Si photodiodes. The birefringence Δ is calculated from the intensities measured from the following relationship

$$Δ n = \frac{λ}{π d} arcsin \sqrt{\frac{{I}_{s}}{{I}_{s} + {I}_{p}}}$$

wherein d is the thickness of the polymer layer and λ=633 nm is the light wavelength of the reading laser. The approximation that reading out takes place perpendicular to the polymer layer is assumed in this formula.
Writing/Erasing Experiments with Polymer B2.4:

The birefringence Δn rose monotonously during the first exposure to light. After exposure of the specimen to light from the writing laser for 2 minutes, the first writing operation was concluded. The resulting phase shift ΔΦ=2π Δn d/λ does not exceed the value ΔΦ=π during this and the following writing operations. The birefringence n of the polymer layer had virtually reached a maximum value of Δn=0.213±0.002 after 2 min.

Δn was erased by rotating the polarization direction of the writing light through 90°. This erasing operation is concluded as soon as Δn=0. This is equivalent to a value of Iₛ=0, which is detected via a diode. The erasing happened here significantly faster than the writing.

Further writing/erasing operations followed this first operation directly according to the same pattern, the diode signals were recorded and the birefringence was calculated. The build-up of the birefringence during the second and all following writing operations was comparable to the first in speed and level.

Results:

The polymer does not fade, which would be read from a successive decrease in the birefringence.

The polymer exceeds the light-induced birefringence value of 0.15, which is very particularly preferred according to the invention.

Comparison of the Light Exposure Properties of Various PAP Materials:

Wavelength of the light λ = 532 nm; power density:
1,000 mW/cm²; transition mode

| | | | Maximum | | |
|---|---|---|---|---|---|
| | Film | Optical | birefringence | Time to | |
| PAP layer | thickness | density at | achieved | Δn = 0.9Δₘₐₓ | |
| from Example: | [μm] | 532 nm | Δnₘₐₓ | [sec] | |
| 2.1 | 0.58 | 0.05 | 0.16 | 740 | s |
| 2.2 | 0.58 | 0.21 | 0.20 | 45 | s |
| 2.3 | 1.50 | 0.03 | 0.18 | 4,200 | s |
| 2.4 | 0.21 | 0.12 | 0.21 | 140 | s |
| 2.5 | 0.20 | 0.81 | 0.21 | 5 | s |
| 2.6 | 0.54 | 0.36 | 0.30 | 540 | s |
| 2.7.1 | 1.60 | 0.34 | 0.13 | 53 | s |
| 2.7.2 | 0.40 | 0.12 | 0.12 | 62 | s |
| 2.8 | 0.47 | 1.60 | 0.19 | 12 | s |
| 2.9 | 0.26 | 0.09 | 0.13 | 85 | s |
| 2.10 | 0.30 | 0.04 | 0.07 | 77 | s |

Result: All the polymers investigated exceeded the birefringence value Δn=0.07, which is preferred according to the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed:

1. An optical storage medium comprising
a) a photoaddressable layer that includes a polymer the molecular structure of which includes at least one structural unit conforming to formula (I) 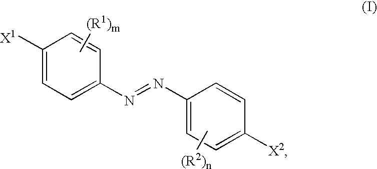
wherein
R¹ and R² independently of one another represent hydrogen or a nonionic substituent,
m and n independently of one another represent an integer of 0 to 4,
X¹ and X² denote X^{1′}—R³ or X^{2′}—R⁴,
Wherein
X^{1′} and X^{2′} represent a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)—, —(CNR⁸—NR⁵)— or —N═N—,
R³, R⁴, R⁵ and R⁸ independently of one another represent hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)—,
R⁶ and R⁷ independently of one another represent hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl or
X^{1′}—R³ and X^{2′}—R⁴ represent hydrogen, halogen, cyano, nitro, CF₃ or CCl₃, and
b) a substrate layer.

2. The optical storage medium of claim 1 wherein the at least one structural unit conforms to formula (II) 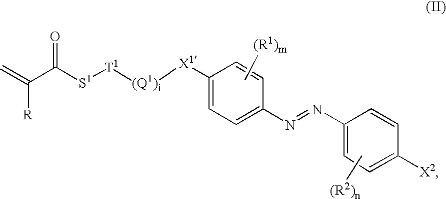
wherein
R represents hydrogen or methyl and
Q¹ represents —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁸)—, —(C═NR⁵)—, —(CNR⁸—NR⁵)—, —(CH₂)ₚ—, p-C₆H₄—, m-C₆H₄— or a divalent radical selected from the group consisting of the following structures 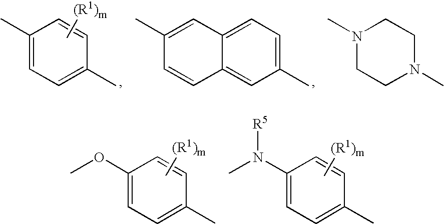
i represents an integer of 0 to 4, with the proviso that where i>1 the individual Q¹ are independent of one another may,
T¹ represents —(CH₂)ₚ—, with the proviso that the CH₂ chain may be interrupted by —O—, —NR⁹— or —OSiR¹⁰₂O—,
S¹ represents a direct bond, —O—, —S— or —NR⁹—,
p represents an integer of 2 to 12, R⁹ represents hydrogen, methyl, ethyl or propyl,
R¹⁰ represents methyl or ethyl.

3. The optical storage medium of claim 2,
wherein Q¹ denotes 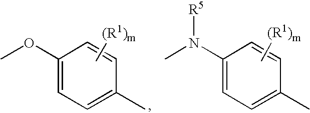
i denotes 1 and
S¹ is —NR⁹—.

4. The optical data storage medium of claim 1 further comprising at least one member selected from the group consisting of a transparent barrier layer, reflection layer and an adhesive layer, said member interposed between said photoaddressable layer and said substrate layer.

5. The optical storage medium of claim 1 further comprising one or more transparent, optically clear, non-scattering, amorphous cover layers.

6. The optical storage medium of claim 2 further comprising one or more transparent, optically clear, non-scattering, amorphous cover layers.

7. The optical storage medium of claim 3 further comprising one or more transparent, optically clear, non-scattering, amorphous cover layers.

8. A process for the production of the optical storage medium of claim 1 comprising
A) dissolving the polymer in a solvent,
B) applying the solution to said substrate to obtain a coated substrate,
C) evaporating the solvent from the coated substrate to obtain a composite film and
D) drying the composite film.

9. An optical storage medium comprising
a) a photoaddressable layer that includes a polymer the molecular structure of which includes at least one structural unit conforming to a member selected from the group consisting of 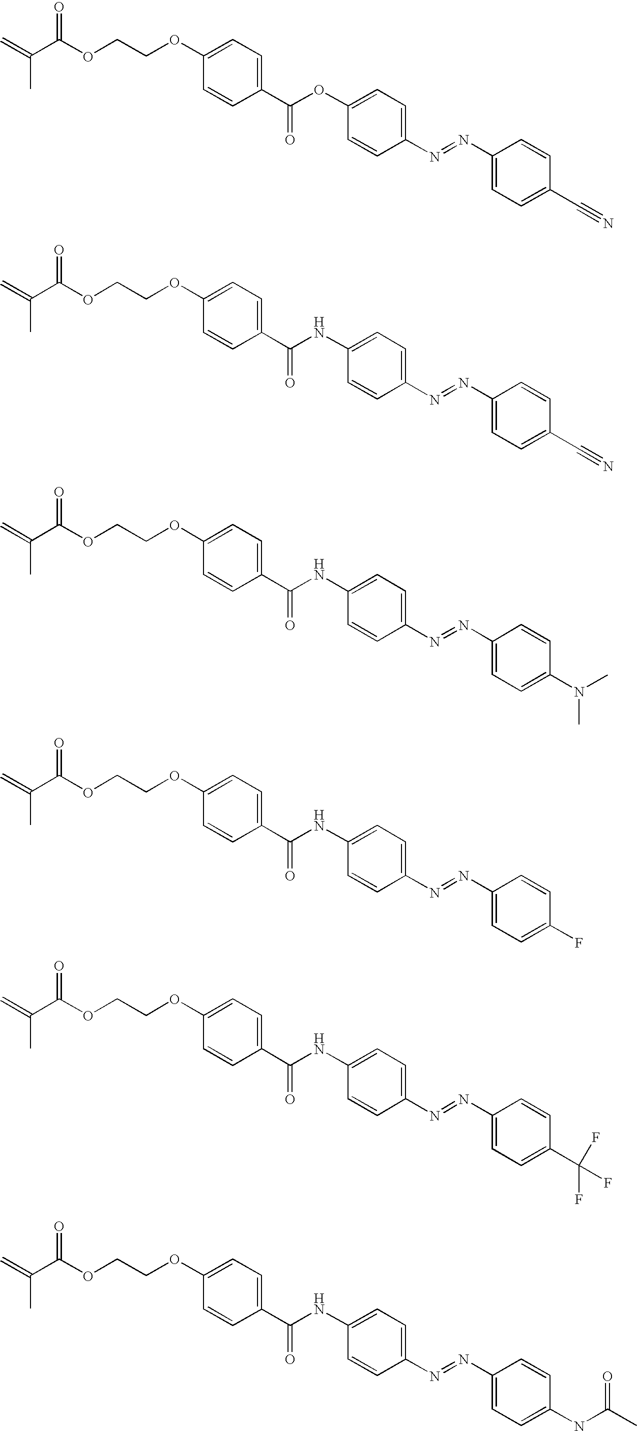 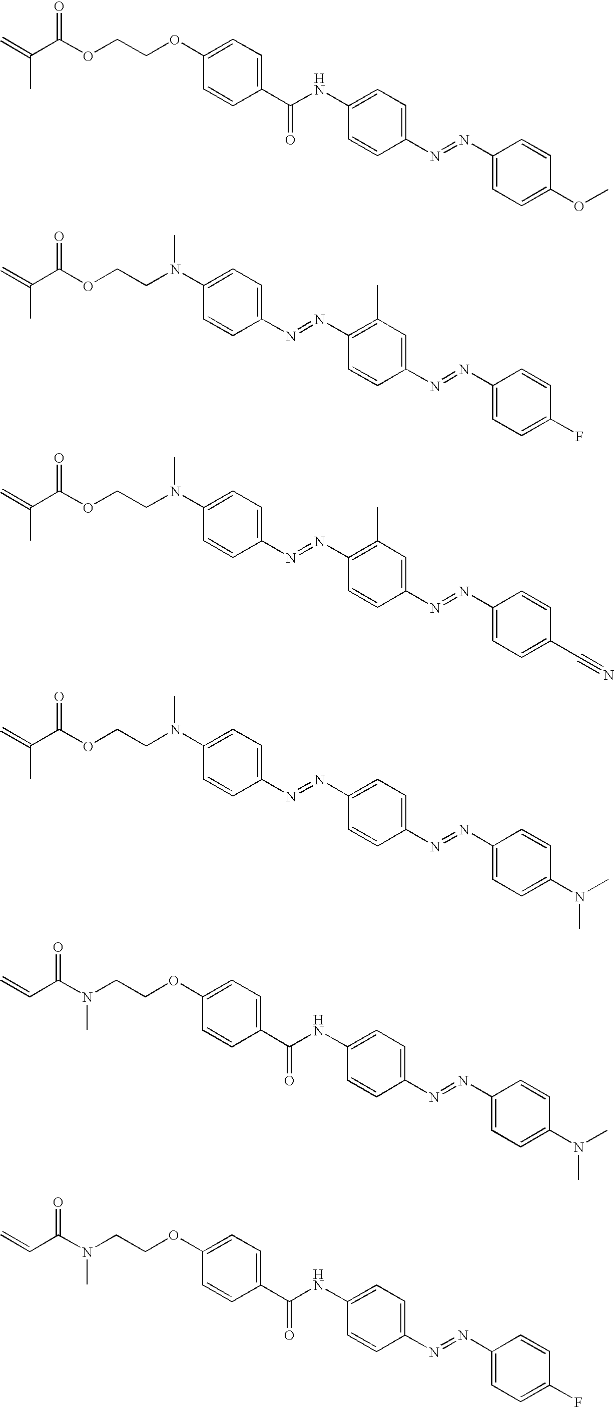 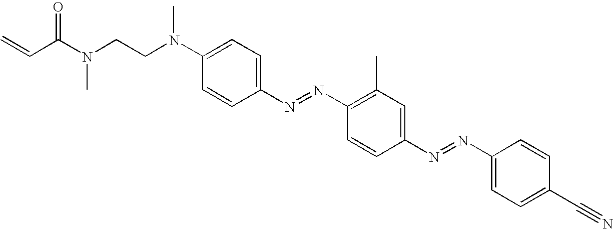
and
b) a substrate layer.

10. The optical storage medium of claim 1 wherein the photoaddressable layer includes a copolymer the molecular structure of which includes in addition to the structural unit conforming to formula (I) a structural unit conforming to formula (III) 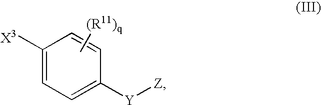
wherein
Z represents a radical of the formulae 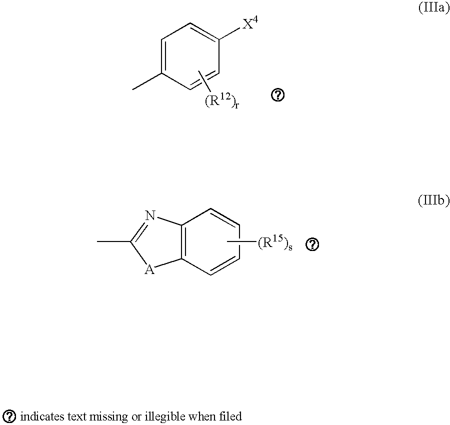
wherein
A represents O, S or N—C₁- to C₄-alkyl,
X³ represents —X^{3′}-(Q²)ⱼ-T²-S²—,
X⁴ represents X^{4′}—R¹³,
X^{3′} and X^{4′} independently of one another represent a direct bond, —O—, —S—, —(N—R⁵)—, —C(R⁶)—, —(C═O)— —(CO—O)—, —(CO—NR⁵)—, —(SO₂)—, —(SO₂—O)—, —(SO₂—NR⁵)—, —(C═NR⁸)— or —(CNR⁸—NR⁵)—,
R⁵, R⁸ and R¹³ independently of one another represent hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or
X^{4′}—R¹³ can represent hydrogen, halogen, cyano, nitro, CF₃ or CCl₃,
R⁶ and R⁷ independently of one another represent hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,
Y represents a single bond, —COO—, —OCO—, —CONH—, —NHCO—, —CON(CH₃)—, —N(CH₃)CO—, —O—, —NH— or —N(CH₃)—,
R¹¹, R¹², R¹⁵ independently of one another represent hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—,
q, r and s independently of one another represent an integer from 0 to 4, preferably 0 to 2,
Q² represents —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)—, —(CNR⁸—NR⁵)—, —(CH₂)ₚ—, p- or m-C₆H₄— or a divalent radical of the formulae 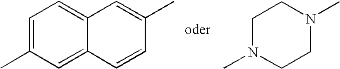
or
j represents an integer from 0 to 4, where for j>1 the individual Q² may have different meanings,
T² represents —(CH₂)ₚ—, wherein the chain may be interrupted by —O—, —NR⁹— or —OSiR¹⁰₂O—,
S² represents a direct bond, —O—, —S— or —NR⁹—,
p represents an integer from 2 to 12, preferably 2 to 8, in particular 2 to 4,
R⁹ represents hydrogen, methyl, ethyl or propyl,
R¹⁰ represents methyl or ethyl.
